(19) United States
(12) Patent Application Publication
(10) Pub. No.: US 2009/0068412 A1
(43) Pub. Date: Mar. 12, 2009

(54) POLYURETHANE UPHOLSTERY

(75) Inventors: A. Michael Nahmias, Wakefield, RI (US); Richard Pierce, Plymouth, MA (US); Marilyn Geller, Brooklyn, NY (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: SHAWMUT Corporation, West Bridgewater, MA (US)

(21) Appl. No.: 12/209,634

(22) Filed: Sep. 12, 2008

Related U.S. Application Data
(60) Provisional application No. 60/971,625, filed on Sep. 12, 2007.

(51) Int. Cl. B32B 3/10; B32B 3/30

(52) U.S. Cl. 428/172; 428/196; 428/221; 428/332

(57) ABSTRACT

Products and methods directed to multilayer upholstery are disclosed. Such upholsteries can be used as a furniture covering or in other covering applications. In many instances, the multilayer upholstery comprises three layers: a clear, cross-linked urethane layer, a textile layer and a polymeric layer between and coupled to the clear and textile layers. Additionally, the multilayer upholstery can contain a solid color or printed pattern. The printed pattern can be derived from a printed textile surface or a print film disposed as one of the layers. Methods for modifying the layers to yield antimicrobial properties, chemical resistance and adhesive bonding between layers are also disclosed.

### CROSS REFERENCE TO RELATED APPLICATIONS

The present application claims the benefit of a U.S. Provisional Application bearing Ser. No. 60/971,625 filed on Sep. 12, 2007, entitled “Polyurethane Upholstery”. The entire contents of the provisional application are hereby incorporated herein by reference.

### FIELD OF THE APPLICATION

The present application is directed to textiles, which can be used as upholstery, and particularly to polyurethane containing upholsteries and textiles.

### BACKGROUND

Polymer upholstery materials are used for a variety of reasons, low cost, water and stain resistance, ease of cleaning, wide range of solid colors and textures. In use are polyvinyl chloride (PVC), nylon, and urethane materials.

The architectural and design communities are currently driven by statistics indicating that commercial and residential buildings are responsible for a large percentage of greenhouse gases in the environment. As a result, architects and designers are interested in designing more energy efficient buildings and furnishing them with more environmentally friendly materials. PVC is one of the materials, which is perceived as having a negative environmental impact during manufacturing and disposal. It can also contribute negatively to indoor air quality during use. The market is hungry for products which provide similar performance characteristics to PVC products but are made from less hazardous materials.

PVC based upholstery materials are the most widely used because they are lower in cost than urethanes and are easy to clean. The softness of PVC is controlled by the amount of plasticizer added to the material. Unfortunately, these plasticizers eventually migrate out of the PVC resulting in a hardening of the material and the propensity to crack. An additional problem is that as these plasticizers migrate out of the PVC they end up in the air. If air turnover is low in a vehicle or building, this can lead to an odor. In addition, there are growing concerns that the airborne plasticizer is unhealthy. Also, PVC is not biodegradable, so is permanent within a landfill and creates hazardous fumes if incinerated or burned in an uncontrolled fire.

Typically the structure is a solid color PVC skin (film) bonded to a non-woven scrim or knit depending on the price point needed. This PVC skin is either calendared or extruded. The PVC is sometimes over-printed to improve color match or patterned design, and embossed to provide a grained surface. Usually the price point for this type of material is $3-$5 per yard, depending on weight and backing type.

If there is a desire for a material providing a softer tactile sensation, a slightly different process is used. In this process PVC along with its plasticizer is suspended in a solvent and the top layer of the final product is cast on a release paper. Then an additional layer of PVC under the solid face layer is cast on top of the eventual top layer; the material is partially dried. The partially dried layer is then heated to a higher temperature, which expands the blowing agent previously added. This expanded PVC, as it is known, is then over-coated and embossed like the solid PVC described above. In addition the expanded PVC materials exhibit the same plasticizer issues as solid PVC. The expanded or cast PVC process also requires the destruction of the casting solvents by incineration to protect the environment. Usually the price point for this type of material is $6-$9 per yard, depending on weight and backing type.

Urethane upholstery is made in a process similar to expanded PVC. However the softness of the urethane is controlled by the amount of cross-linking sites built into the polymer and the degree of cross-linking achieved by catalyst level added to the compound. The solvents used in manufacture still have to be incinerated but there is no plasticizer used so it causes no migration and hardening and cracking problems. However, this material can be relatively much more expensive; usually the price point for this type of material is $20-$30 per yard, depending on weight and backing type.

In addition, furnishings and equipment (e.g., tables and chairs used in medical offices and examination rooms) that are subjected to harsher cleaning solvents such as bleach and other medical cleaning solutions require specialized upholsteries capable of withstanding such procedures. Unfortunately, many current upholsteries used for these applications tend to degrade after being subject of a few cleaning cycles, and/or have a tactile feel that is hard and plastic-like. As well, when printing is desired on such upholsteries, bleach and other medical cleaning solutions can tend to degrade these printings.

### SUMMARY

Some exemplary embodiments of the present invention are drawn to a multilayer upholstery. The upholstery can include a clear layer of cross-linked urethane that can be configured to be externally exposed. A textile layer and a light-stable polymeric layer located between, and coupled to, the clear and textile layers can also be included. The multilayer upholstery can optionally include a printed pattern that is visible through the clear layer.

Various aspects of some embodiments are directed to the clear layer. In one aspect, the clear layer can have an embossed surface. In addition, the clear layer can be coupled to a removable embossing paper. The clear layer can also be in direct contact with the polymeric layer. At least a portion of the clear layer can be resistant to medical cleaning solutions. In a preferred embodiment, at least a portion of the clear layer can be resistant to bleach. The clear layer can also include of an antimicrobial additive. The antimicrobial additive can be at least one of an antifungal agent, an antiviral agent and an antibacterial agent. The antibacterial agent can further be comprised of a silver-based antibacterial agent.

Some embodiments are directed to the composition and appearance of the layers in the multilayer upholstery. In one aspect, the cross-linked urethane can comprise an aliphatic cross-linked urethane. Furthermore, the cross-linked urethane can be comprised of at least one of a polyester and a polyether. In another embodiment, the cross-linked urethane can comprise a polycarbonate. In another aspect, the clear layer can have a thickness in a range of about 10 μm to 50 μm. In some of the embodiments directed to the polymeric layer, it can be comprised of a urethane-based material. The polymeric layer can also be comprised of an acrylic-based material. In another embodiment, the polymeric layer can be clear. The polymeric layer can also have a thickness in a range of about 20 μm to 70 μm.

The multilayer upholstery also has a printed pattern that can be visible through the clear layer. The printed pattern can be printed on the textile layer. In another embodiment, the printed pattern can comprise a printed film disposed between the polymeric layer and the textile layer. The printed film can be comprised of at least one of an ethylene acrylic acid modified polyethylene, an ethylene methylacrylic acid modified polyethylene, an ethylene vinyl acetate modified polyethylene and a similar polymer.

Some embodiments are directed to the textile layer. The textile layer of the multilayer upholstery can be comprised of recycled material. The multilayer upholstery can be the exposed portion of a piece of medical furniture. It can also be PVC-free. An exemplary embodiment is where the multilayer upholstery can be configured to withstand at least about 100,000 double-rubs.

In another embodiment, the multilayer upholstery comprises a clear layer of a cross-linked urethane configured to be externally exposed, a textile layer, and a light-stable, pigmented polymeric layer located between, and coupled to, the clear and textile layers with the multilayer upholstery having a solid color visible through the clear layer. The clear layer can comprise an embossed surface. The clear layer can also have a thickness in a range of about 10 μm to 50 μm. The clear layer can also be in direct contact with the polymeric layer. The polymeric layer can be comprised of an acrylic-based material. The polymeric layer can have a thickness in a range of about 35 μm to 100 μm. In a related embodiment, the solid color multilayer upholstery can also be PVC-free. The solid color multilayer upholstery can also be configured to withstand at least about 100,000 double-rubs.

Some embodiments are directed to methods for preparing a polyurethane upholstery which comprises providing a clear, cross-linkable urethane layer, attaching a polymeric layer to the clear layer and adhering a textile layer to the polymeric layer thereby generating the upholstery. Additionally, the methods can include casting the clear layer on a pattern casting paper. Furthermore, a precursor can be cast on the casting paper. The precursor can have a thickness in a range of about 10 μm to 50 μm. In related embodiments, providing a clear layer can comprise rendering at least a portion of the clear layer resistant to bleach. Another aspect can comprise drying the clear layer as a method of curing it.

Some embodiments are directed to the step of attaching the polymeric layer to the clear layer, and can comprise nipping the clear layer and the polymeric layer together using at least one roller. Attaching the polymeric layer can further include drying but not fully curing the polymeric layer. Another aspect can be laminating a printed film to the polymeric layer. Further, in laminating the printed film, the process of printing can comprise printing a flexographic printed pattern on the printed film. In addition, flexographic printing can comprise a rate of at least 100 yards per hour. Another aspect directed to the step of attaching can be adding dye to the polymeric layer to create a dye pigmented polymeric layer.

Additional embodiments for preparing the polyurethane upholstery can include embossing the clear layer. Another aspect of the method can include adding an adhesive between the polymeric layer and the textile layer. The method can include using the upholstery as a covering for a furniture. There are also embodiments that can comprise using the upholstery as a portion of an interior of a vehicle.

Other exemplary embodiments are directed to polyurethane upholstery made in accord with any of the methods discussed in the present application. The steps can be further delineated in a manner consistent with any of the details describing each of the steps in the present application. The upholstery can also be characterized by the use of additional steps, which can include techniques familiar to those skilled in the art.

### BRIEF DESCRIPTION OF THE DRAWINGS

A need persists for new upholsteries that can eliminate the use of PVC-based materials, while providing such functionalities as desirable tactile softness, and printability. It can also be desirable to achieve any of such functionalities while having the upholstery resist exposure to medical cleaning solutions. Attaining such functionalities while maintaining a desirable market price for the upholstery is also desirable.

Aspects of the present invention will be more fully understood from the following detailed description taken in conjunction with the accompanying drawings (not necessarily drawn to scale), in which:

FIG. 1A is a schematic drawing of a multilayer printed upholstery 100 comprising a clear layer 110, a polymeric layer 120 and a textile layer 130 with optional print pattern 136 on the surface of the textile in accord with some embodiments of the present invention.

FIG. 1B is a schematic drawing of a multilayer upholster 105 comprising a clear layer 115, a polymeric layer 125, a printed film 140 and a textile layer 135 in accord with some embodiments of the present invention.

FIG. 2 is a schematic drawing of a multilayer solid color upholstery 200 comprising a clear layer 210, a pigmented acrylic layer 220 and a textile layer 230 in accord with some embodiments of the present invention.

FIG. 3A is a flow diagram describing the steps involved in manufacturing a printed upholstery comprising providing a clear layer 310, attaching a polymeric layer to the clear layer 320 and adhering a printed textile layer to the polymeric layer 330 in accord with some embodiments of the present invention.

FIG. 3B is a flow diagram further describing the steps involved in manufacturing a printed upholstery comprising providing a clear layer 315, attaching a polymeric layer to the clear layer 325, printing a printed film 340, laminating a printed film to the polymeric layer 350 and adhering a printed textile layer to the printed film 335 in accord with some embodiments of the present invention.

### DETAILED DESCRIPTION OF EMBODIMENTS

Some embodiments of the present invention are drawn to compositions and methods relating to urethane-based upholsteries. Such upholsteries can be formulated as a multilayered upholstery having an external-facing, clear, cross-linked urethane layer, a polymeric layer coupled to the clear layer, and a textile coupled to the polymeric layer. The cross-linked urethane layer can be formulated to resist degradation upon contact with medical cleaning solutions, and/or can be embedded with one or more types of antimicrobial additives. This can be advantageous when the upholstery is used in applications needing resistance to harsh solvents, such as in furnishings for medical applications. The multilayered nature of the upholstery can allow decreased use of urethane in the upholstery (e.g., a thinner urethane layer versus what would be used in conventional urethane upholstery), which can help decrease the cost of the product.

The clear nature of the cross-linked urethane layer can also be advantageous by allowing a pigmented polymeric layer to be visible, or a printed pattern to be visible, therethrough, thereby potentially inhibiting contact between the printed pattern and a cleaning solution. When a printed pattern is visible through the cross-linked urethane layer, the polymeric layer can also be clear, which can allow the printed pattern to be embedded as a film between the polymeric layer and the textile, or for the printed pattern to be directly imprinted on the polymeric layer and/or textile layer. The polymeric layer can also be formulated as a material that can be light-stable, impart a “soft” tactile feel to the upholstery, and/or can be laminated to the cross-linked urethane layer without interstitial bubbling and/or stretching of a layer.

These potential aspects, among others, of the present invention will be discussed in further detail within the present application.

### DEFINITIONS

So that the invention may more readily be understood, certain terms are defined as follows:

The term “clear” as used herein is defined as at least partially transparent to visible light. In various embodiments, a clear layer can refer to a layer that is at least about 50%, 60%, 70%, 80%, 90%, 95%, 99% transparent to one or more wavelengths of visible light.

The terms “curing” and “cured” as used herein refer to the process of inducing a change in a material property, such as increasing the viscosity, changing the material from a liquid to a solid, or hardening a material. Curing can be performed by drying (e.g., air drying or adding heat), solvent removal, or inducing a reaction (e.g., impinging light on a light sensitive composition or adding a catalyst to a reactive composition).

The term “double-rub” is associated with a test method for materials in which a sample (e.g., a textile-based material) is oscillated back and forth in contact with a substrate acting as the abradant (e.g., a cotton material) until the sample shows a breakage or noticeable wear. One oscillation of the abradant constitutes a double-rub. The greater the number of oscillations, the more resistant the sample is to abrasion. In some instances, a double-rub is associated with a test of the American Society of Testing and Materials (ASTM) such as ASTM D4157-07, which can be performed on a Wyzenbeek machine. Other variations include any other oscillatory rub test approved by the Associate for Contract Textiles.

The terms “flexographic” and “flexography” as used herein is a method of surface printing that utilizes a positive mirrored image plate of the print image upon which ink is deposited. The image plate containing ink then contacts the print material and transfers the image.

The term “medical cleaning solution” as used herein is defined as any medical grade solution used for disinfecting or sterilization that contains chlorine or chlorine derivatives.

The term “pliable” as used herein refers to the ability to move or bend with minimal pressure.

The term “precursor” as used herein is defined as an initial or intermediate composition that transforms to a final composition by any number of mechanisms (e.g., drying, reaction, curing etc.). For example, a precursor can comprise urethane that has not been cross-linked, or partially cross-linked, before reaching some final cross-linked state.

The terms “soft” and “softness” as used herein refers to tactile aesthetics, wherein the surface is fine to the touch and/or smooth in texture.

The term “upholstery” as used herein is defined as the outer covering of an object which can utilize some type of textile-based material. One example is a piece of furniture, wherein the furniture can be one of, but is not limited to, a piece of medical furniture, an interior part of an automobile, an office furniture and a residential furniture.

The terms “urethane” and “polyurethane” are used interchangeably, and refer to a polymer having repeat units formed from the reaction of molecules having multiple isocyanate groups and molecules having multiple alcohol groups. Note that the term “urethane” is distinct from the substance ethyl carbamate.

Other terms are defined explicitly elsewhere in the present application, implicitly through the context of their usage in the present application, and/or having their ordinary meaning as understood by those skilled in the art.

### Multilayered Upholsteries

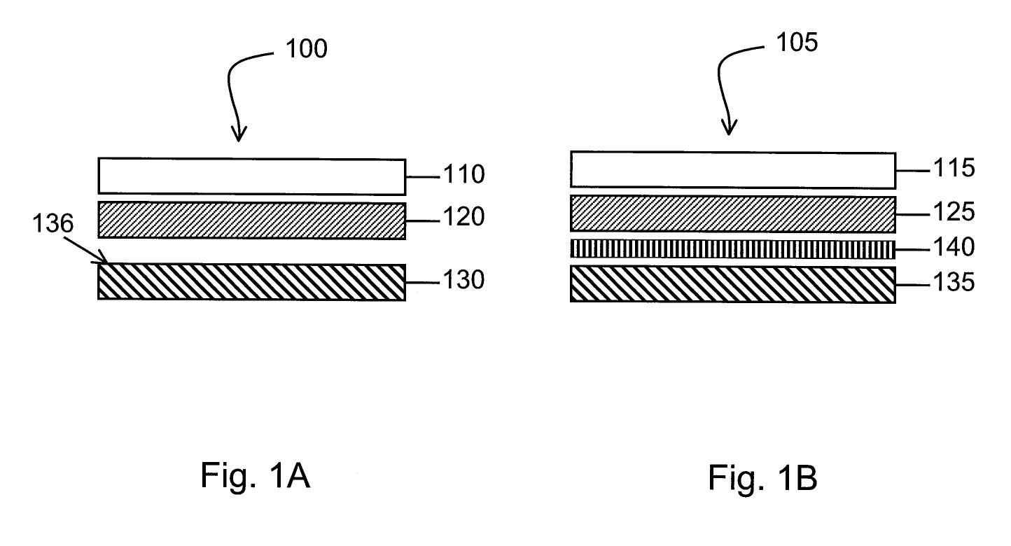

Some embodiments of the present invention are directed to a multilayer upholstery. In one embodiment, the multilayer upholstery 100 comprises three layers as exemplified in FIG. 1A. A clear layer 110 (e.g., comprising cross-linked urethane) can be coupled to a textile layer 130 and a polymeric layer 120. The multilayer upholstery 100 can also be a portion of the exterior surface of a piece of furniture. The furniture can be one of, but is not limited to, a piece of medical furniture, an interior part of a vehicle, office furniture and a residential furniture. These embodiments can include one or more other layers or compositions disposed between, on top of, or below any of the layers 110, 120, 130.

The following description of various individual functions and features of multilayer upholsteries can be combined in any consistent fashion to provide embodiments of the present invention. Accordingly, specific descriptions of the various layers, properties of layers, print films, etc. can be combined to provide a multilayer upholstery within the scope of the present invention. Thus, the practice of the concepts in the present application are not to be limited to any specific embodiment disclosed herein.

A number of advantageous properties can be associated with such multilayer upholsteries. For example, in many embodiments, a multilayer upholstery can further comprise a printed pattern that is visible through the clear layer. In other embodiments, the multilayer upholstery can comprise a color visible through the clear layer (e.g., a color provided by pigmentation in a polymeric layer 120); the color can be opaque or at least partially transparent. Some embodiments can utilize a combination of coloring and printing. Accordingly, such embodiments can allow for upholsteries having substantial decorative flexibility. Also, the multilayer upholstery can be PVC-free, thus forming a product without the typical associated disadvantages of utilizing PVC. The upholstery can also be configured to be durable such that it exhibits substantial abrasion resistance. For instance, the multilayer upholstery can be configured to withstand at least 100,000 double-rubs. Other abrasion tests can also be utilized to show abrasion resistance (e.g., a Martindale test such as ASTM D4966-98, in which the multilayer upholstery exhibits resistance to at least about 50,000, 75,000, or 100,000 cycles).

Multilayer upholstery embodiments that contain a printed pattern can include but are not limited to printing on a side 136 of textile material 130 facing the clear, cross-linked urethane layer. The printed pattern could also be on either side of the polymeric layer 120, though would be on the side facing the clear, cross-linked urethane layer if an opaque pigment is present in the polymeric layer 120. Alternatively, a multilayer upholstery 105 can include a separate printed film layer 140, as seen in FIG. 1B. The printed film layer 140 which can be added between the polymeric layer 125 and the textile layer 135, with the clear, cross-linked urethane layer 115 disposed on the exterior surface. An advantage of such an embodiment would enhance print pattern durability by protecting the print film from external factors, such as medical cleaning solutions, with two layers, the clear and polymeric layers. Furthermore, the upholstery can be comprised of both a printed textile and a printed film present between the polymeric layer and the textile layer. The printed film 140 can be in direct contact with the polymeric layer 125 or an adhesive can be disposed between the layers. In the former, the polymeric layer 125 and printed film 140 can have properties that make the layer self-adhering without the use of an adhesive. An adhesive can also be disposed between the printed film 140 and the textile layer 135. In some embodiments that contain the printed textile layer, the textile can be solid or pattern colored by techniques well known in the fabric world. The textile can be colored or pattern printed without processing additives, which can impede adhesion.

In embodiments utilizing a printed film, the films can be made from any suitable materials, including those known to one skilled in the art. In some embodiments, the printed film can be comprised of at least one of an ethylene acrylic acid modified polyethylene, an ethylene methylacrylic acid modified polyethylene, an ethylene vinyl acetate modified polyethylene and a similar polymer. The printing film can also be comprised of aliphatic urethane. In some embodiments, the printed film can further comprise titanium dioxide, which can be used to provide opacity and/or whiteness. Additionally, other materials can be included to improve the printing films such as processing aids (e.g., fluoropolymer) can be used to reduce dye streaks. The printing films, as well as any of the layers, can be corona discharged to alter the surface energy such that adjacent layers can exhibit enhanced affinity to one another relative to the native surfaces.

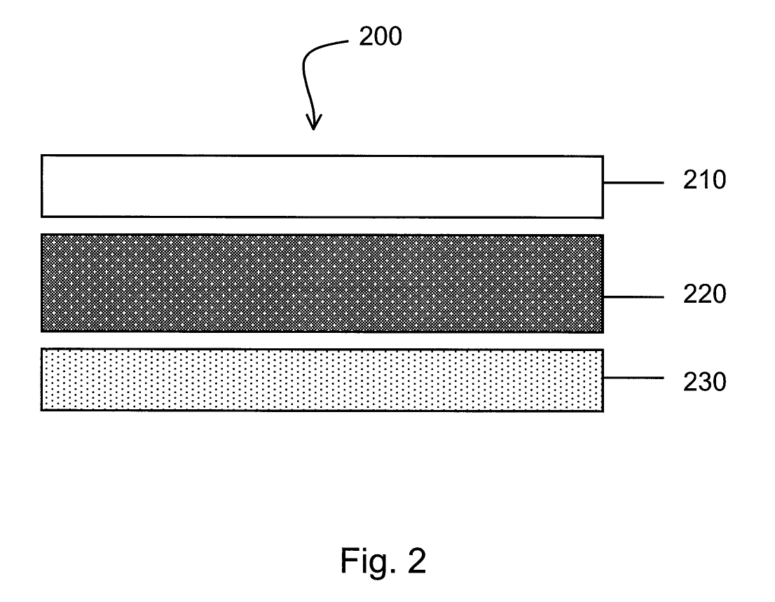

Other embodiments are drawn to a multilayer upholstery that does not utilize a printed pattern. Such upholsteries can be utilized in a variety of applications such as coverings in vehicle (e.g., automobile linings and seats and other vehicle interior surfaces). Such embodiments are exemplified by the schematic of FIG. 2. An upholstery 200 can include a clear layer 210, a polymeric layer 220, and a textile layer 230. The polymeric layer 220 can be colored using pigments, dyes, and other coloring compositions including those known to one skilled in the art. The coloring can make the polymeric material opaque (e.g., be a solid color) or can add coloration while maintaining some degree of transparency in the polymeric layer to visible light. In some of these embodiments the polymeric layer can have a thickness in a range greater than about 20 μm or greater than about 35 μm, and/or less than about 150 μm or 100 μm.

In general, a clear layer of a multilayer upholstery can comprise a cross-linked urethane. In some embodiments, the clear layer can be configured such that it is the externally exposed portion of the upholstery. The clear layer and/or cross-linked urethane can be formulated to exhibit resistance to degradation when contacted with medical cleaning solutions such as bleach or other chlorine-containing compounds in such solutions. Accordingly, such clear layers can be suitable for covering furnishings and other pieces that can be exposed to microbial contamination (e.g., medical examination tables).

The urethane of the clear layer can be formed by reacting one or more types of molecules having multiple isocyanate functionalities with one or more types of molecules having multiple alcohol functionalities. Such reactants can be aqueous-based or solvent-based (e.g., non-aqueous based). Cross-linking can be achieved in any manner including utilizing techniques known in the art. For example, cross-linking agents can be added to the urethane/urethane forming composition such as molecules having three or more hydroxyl and/or amine terminating groups. Though a variety of urethanes (e.g., aromatic-based urethanes) are suitable with the present invention, some embodiments utilize aliphatic based urethanes, which can exhibit decreased light-sensitivity relative to some aromatic urethanes. In some embodiments, the urethane can be either a polyether or a polyester—though some particular embodiments utilize polyesters as they can exhibit better stain resistance relative to polyethers in some situations. Particular embodiments can also be drawn to urethanes that are polycarbonates, which can also exhibit enhanced resistance to medical cleaning solutions. Any consistent combination of the urethanes discussed can be utilized (e.g., a urethane comprising an aromatic polyester, or a polycarbonate/aliphatic polyester). Non-limiting examples of commercial products that may be used as potential components of the clear layer include: SOLUOL Solucote® 6629 from DSM Neo-Sol, Inc., SOLUOL Solucote® 13086 from DSM Neo-Sol, Inc., Stahl SU-13-550 from Stahl USA Inc., various coatings available from the Permuthane® Division of Stahl, Krystalflex® polyurethanes by Huntsman, Hauthane HD-2001 from Hauthaway Corporation, and Laromer® LR8949 from BASF Corporation.

In some embodiments, the clear layer can be thin to help reduce the use of expensive materials associated with the clear layer while providing the desired functionality (e.g., resistance to degradation by medical cleaning solutions). For instance, the clear layer can have a thickness in a range greater than about 10 μm and/or less than about 50 μm. In other embodiments, the clear layer can comprise other additives. For instance, the clear layer can comprise an optional antimicrobial additive, wherein the antimicrobial can confer resistance or be otherwise pathogenic to any number of microorganisms and can encompass at least one of an antifungal, an antiviral and an antibacterial agent, or any combination thereof. The antibacterial agent can also be further comprised of a silver-based antibacterial agent. The antifungal agent can also be further comprised of a copper-based antifungal agent. By using a thin layer, less of the additive can also be utilized relative to forming a coating including solely a polyurethane.

In some embodiments, the clear layer can include texturing on the external facing surface. The texturing can be imparted using embossing techniques. For instance, the clear layer can be coupled to a removable embossing paper that results in an embossed surface on the external surface. Alternatively, the clear layer can be embossed mechanically by imprinting the layer at a convenient point during or after the manufacturing process for the upholstery. Additionally, the clear layer 110 can be in direct contact with the polymeric layer 120 as in FIG. 1A, or it can be coupled to the polymeric layer through an adhesive. In the former, the clear layer and the polymeric layer can be formulated to be self-adhering, or the contacting surfaces can be treated (e.g., corona treated) to enhance adhesion.

A polymeric layer in some embodiments can be a layer located between and coupled to the clear and textile layers. While the thickness of the polymeric layer can be anything consistent with embodiments herein, in some instances the thickness is greater than about 20 μm and/or less than about 100 μm or about 70 μm. In some embodiments, the polymeric layer can be in direct contact with the clear layer, while in some other embodiments an adhesive can be used to bond the layers. Additionally, the polymeric layer can be bonded to a textile layer through an adhesive disposed between the polymeric and textile layers. The polymeric layer can also be in direct contact with the textile layer. In additional embodiments as shown in FIG. 1B, the polymeric layer 125 can be separated from the textile layer 135 with a printed film 140. The polymeric layer can be in direct contact with the printed film or an adhesive can be disposed between the polymeric layer and the printed film.

In many embodiments, the polymeric layer can be light-stable (i.e., showing substantially no discoloration upon exposure to visible light). The polymeric layer can also be clear or opaque and/or exhibit some coloration (e.g., through the use of a pigment incorporated within the layer composition). Accordingly, the use of a clear polymeric layer can aid embodiments utilizing a printed pattern. In some embodiments, the polymeric layer can impart a soft tactile feel to the upholstery, which can be desirable in furnishing covering applications. Additionally, or alternatively, the polymeric layer can also act as a filler for upholsteries when the clear layer presents an irregular surface. For example, when an embossing paper is utilized to cast the clear layer, the thinness of the clear layer can result in the clear layer conforming to the texture of the embossing paper pattern, resulting in an irregular surface to which the polymeric layer is laminated. Accordingly, the polymeric layer can be formulated to fill the gaps in the irregular surface, and can create a smooth surface upon which a printed film can be laminated. Thus, such an embodiment can reduce bubbling and gaps that can occur.

A variety of formulations can be used for the polymeric layer to impart any number of the characteristics described herein. For instance, the polymeric layer formulation can be chosen to enhance manufacturing with a clear, cross-linked urethane layer to result in a lamination that substantially eliminates bubbling between the layers, or stretching of one layer relative to another. Non-limiting examples of materials that can be utilized include urethanes and acrylic-based materials such as an ethylene acrylic acid copolymer. The use of a non-urethane based material in the polymeric layer can serve to reduce the cost of the upholstery while maintaining at least some of the advantages of conventional urethane coverings since acrylic-based materials can have a cost/quantity value that is about two to about three times that of a urethane material.

The textile layers of the multilayer upholstery used in some embodiments can be comprised of typical textile materials utilized as coverings in any of the applications discussed herein (e.g., automobile interior surfaces, coverings for medical/dental furniture etc.). Accordingly, a textile layer can comprise non-woven or woven materials or any mixture thereof. As well, the textile can be formed from fibers that are naturally-occurring, man-made, or some combination of the two. For instance, the textile can be a knit such as a polyester knit. In some embodiments, the textile layer can be made from recycled materials alone (e.g., 100% recycled polyester material), or mixed with other materials; this can yield additional cost savings and environmental conservation. Of course, textiles can also be constructed from virgin materials. In addition, the textile can be made from naturally occurring fibers, e.g., organic cotton fibers. In some embodiments, the textile can be selected for tactile softness and/or pliability of the finished product. In some embodiments the textile layer can include a printed pattern that is visible through the clear layer. In some embodiments, the textile layer can be a solid color. In preferred embodiments, the textile can be colored dyed or pattern printed without processing additives which can impede adhesive bonding. These techniques of textile color dying and pattern printing are well known by those of ordinary skill in the art. In some embodiments the textile can contain a combination of color pigmentations and printed patterns.

### Methods of Manufacturing Multilayered Upholsteries

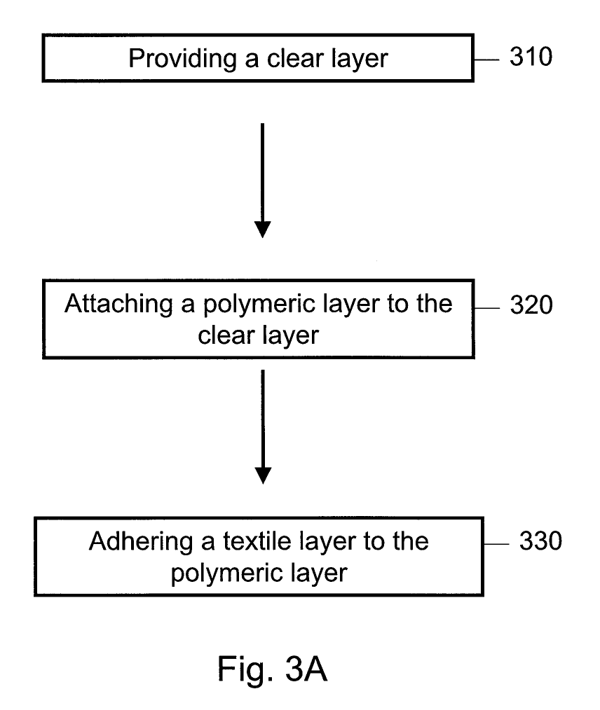

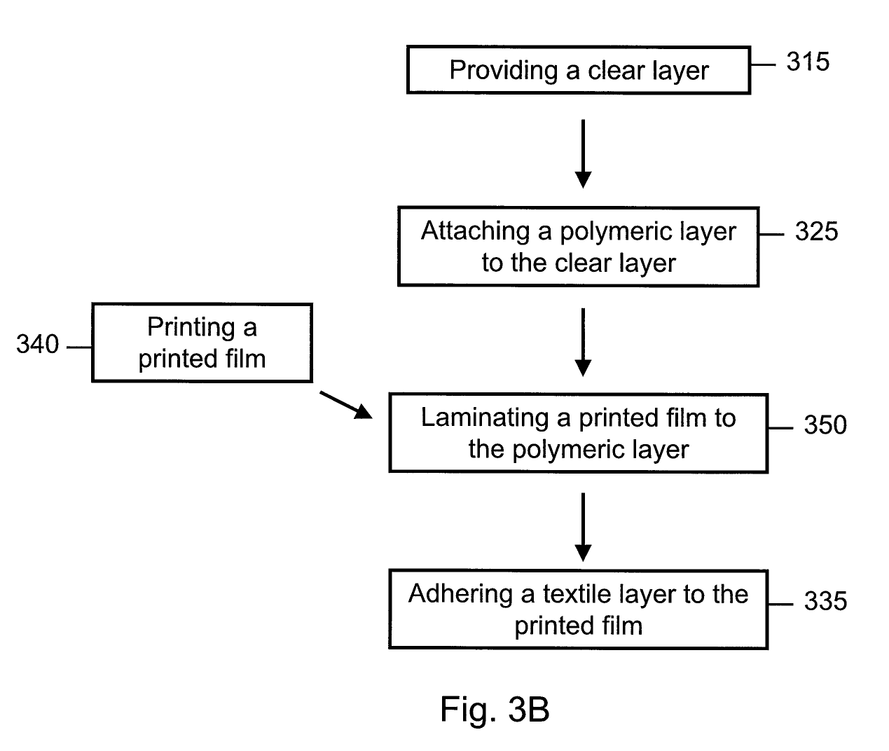

Some embodiments are directed to a method of preparing and manufacturing a multilayer upholstery. FIGS. 3A and 3B present flow diagrams of some methods consistent with embodiments of the present invention. After assembly, the upholstery can be used as a covering for a piece of furniture such as a piece of medical furniture, an interior part of a vehicle, office furniture, or residential furniture. Such upholsteries can also be prepared to incorporate patterns or colors customized to a user's preference. Alternatively, or in addition to, the upholsteries can be manufactured with a textured surface.

As shown in FIG. 3A, a clear layer can be provided 310. The clear layer can be formed in any number of ways, including using techniques known to one skilled in the art. For example, the clear layer can be casted onto a casting paper, the latter which can be reusable in some instances. In some instances, the casting paper can have a pattern imprinted thereon. When a precursor to the clear layer is applied to the patterned casting paper, the precursor can be subsequently cured to form the clear layer with the texture. In other instances, the paper can be relatively smooth and texture can be imparted using some type of mechanical imprinting after the clear layer is at least formed enough to keep an imprinted pattern. Curing can include cross-linking the urethane and/or otherwise reacting components in the precursor to form the cross-linked urethane. In some cases, the precursor is partially cross-linked, such that the urethane clear layer has adhesive properties for adhering to another layer (e.g., polymeric layer). The precursor can be applied to form a clear layer thickness that is consistent with any of the thicknesses disclosed herein. For example, about 1 mil of precursor can be applied to form the layer.

Precursors suitable for use in forming a clear layer can include any of the materials used to form a cross-linked urethane clear layer consistent with any of the descriptions in the present application (e.g., rendering a clear layer resistant to contact with medical cleaning solutions, which can contain chlorine). Accordingly, a precursor formulation can include at least one type of molecule with multiple isocyanate functionalities and at least one type of molecule having multiple alcohol functionalities. The precursors can also include other materials such as cross-linkers and/or any of the antimicrobial agents discussed herein.

The method can also include attaching the polymeric layer to the clear layer 320. An adhesive can be used in some embodiments to attach the polymeric layer to the clear layer. Alternatively, or in addition, the clear layer and/or polymeric layer can have properties that cause the layer to exhibit attraction to one another. The layers can be nipped together under pressure and temperature conditions, as understood by one skilled in the art, to cause attachment. Nipping with at least one roller can cause the layers to flatten and compress together. The nipping process can be carried out to prevent bubbles from forming between the layers and/or overstretching of any layer. In other embodiments, the layers can be dried but not fully cured.

A textile layer can be adhered to the polymeric layer in a step 330 consistent with some embodiments of the invention. Such adhering can be intrinsic to the layers being attached, and/or can be facilitated using an adhesive. Such a textile layer can be printed upon, and/or the polymeric layer can be printed upon. In other instances, the polymeric layer includes coloring as described herein.

Methods for creating a multilayer upholstery that include a printed pattern are exemplified by the flow diagram shown in FIG. 3B. In some embodiments, after providing a clear layer 315, and a polymeric layer has been attached to the clear layer 325, a printed film can be laminated to the polymeric layer 350. The printed film can be obtained in any way, including optionally printing the film 340 as an additional step of the method. The polymeric layer can be partially cured or the polymeric layer can be fully cured. The polymeric layer can also be in direct contact with the printed film (e.g., the printed film and the polymeric layer being self-adhering to one another), or an adhesive can be added between the polymeric layer and the printed film. The layers laminated to the printed film can be partially cured or fully cured. Then a textile layer can be adhered to the laminated product 335. In some embodiments an adhesive can be disposed between the printed film and the textile to couple the layers.

In some embodiments that contain a print film, the printed film contains a printed pattern, which can be manufactured as a step 340 of the manufacturing process. The printed film can be printed 340 by methods such as, but not limited to, flexographic printing, digital printing, thermal printing, roller printing, lithography, screen printing and laser printing. Flexographic printing, which can have the benefit of being low cost, having good repeatability and high output, and can offer pattern versatility with rapid printing speeds. In some embodiments, a flexographic printing method can be used to generate the pattern on the printed film. In some additional embodiments, the pattern printing rate can be at least 100 yards per hour. For certain applications, digital printing can also be warranted. This can be advantageous since digital printing requires no plate and cylinder costs, and can allow for low (300 yard) minimum product production runs.

Similar to the processes as described above, a colored polymeric layer can be attached to a clear, cross-linked urethane layer. The polymeric layer can be colored with pigment, a suitable dye, or other coloring processes, including those known to one skilled in the art. The polymeric layer can have any thickness (e.g., in the range of about 35 μm to about 100 μm) to act as a smoother and filler when attached to a clear layer.

### EXAMPLES

The following examples are provided to illustrate some embodiments of the invention. The examples are not intended to limit the scope of any particular embodiment(s) utilized.

### Example 1

### Polyurethane Upholstery with Printed Textile

We manufactured the polyurethane upholstery of this example in two steps. First we prepared the fabric (woven) or nonwoven material to be included in the structure with either solid or patterned coloration by techniques well known in the fabric world. This fabric or non-woven must be colored without processing additives, which impede adhesion.

The second step is done all in line. It begins with a pattern casting paper with the design desired for the final surface of the product. A cross-linkable urethane topcoat containing antimicrobial additives is cast on this paper and dried in an oven. In the next station a second urethane layer is laminated to the optically clear urethane already applied. This second layer is dried but not fully cured. Next the previously printed fabric or non-woven is laminated to the second urethane layer and this layer is cured in an oven. Then the structure is removed from the patterning or embossing paper so that the paper can be reused. The final product is inspected and wound into bolts for sale.

Although these steps could be conducted one at a time, out of line, there are several advantages to this process. The paper is only unwound and rewound once, resulting in less damage to the paper so that it can be reused several times. The repeated oven exposures of the top face of the urethane result in a fully cross-linked material with excellent resistance to cleaning solvents. The middle layer can be dried but not fully cured so that it can be used as an adhesive for the printed fabric or non-woven, thus eliminating an adhesive. The textile laminating is best conducted in line because it facilitates the removal of the structure from the casting paper with out tearing of the cast urethane layers. Overall the end effect of this is that this product can be sold at $15 per linear yard, at least $5 and up to $15 less that the traditional urethane product.

### Example 2

### Polyurethane Upholstery with Printed Film

We manufactured the polyurethane upholstery of this example in two steps. First we prepared a film including either aliphatic urethane or ethylene acrylic acid modified polyethylene blended with linear low-density polyethylene and blow or cast a film. The ethylene acrylic acid modified polyethylene can be replaced by either the ethylene methylacrylic acid modified polyethylene, ethylene vinyl acetate modified polyethylene and other similar polymers having polar groups and low shrink force when heated. Polyethylene or polypropylene homopolymers are not suitable. This film is corona treated in line to enhance its printability and conditions are used to print it without stretching the film. Urethane inks compatible with the middle urethane layer described below and not containing any significant levels of waxes and other lubricants, which impede lamination bonds, are used.

The second step is done all in line. It begins with a pattern casting paper with the design desired for the final surface of the product. A cross-linkable urethane topcoat containing antimicrobial additives is cast on this paper and dried in an oven. In the next station a second urethane layer is laminated to the optically clear urethane already applied. This second layer is dried but not fully cured. Next the previously printed film is laminated to the second urethane layer and is cured in an oven. Finally an additional urethane adhesive is used to bond a textile with limited 4 way stretch to the back of the printed film, then the structure is removed from the patterning or embossing paper so that the paper can be reused. The final product is inspected and wound into bolts for sale.

Although these steps could be conducted one at a time, out of line, there are several advantages to this process. The paper is only unwound and rewound once, resulting in less damage to the paper so that it can be reused several times. The repeated oven exposures of the top face of the urethane result in a fully cross-linked material with excellent resistance to cleaning solvents. The middle layer can be dried but not fully cured so that it can be used as an adhesive for the printed film, thus eliminating an adhesive. The film layer has much lower manufacturing costs and other advantages, which have already been discussed. The textile laminating is best conducted in line because it facilitates the removal of the structure from the casting paper with out tearing of the cast urethane layers and the printed film structure. Overall the end effect of this is that this product can be sold at $15 per linear yard, at least $5 and up to $15 less that the traditional urethane product.

The polyurethane upholstery of the invention has a number of advantages over prior art upholsteries including enhanced aesthetics, design flexibility especially when a printed film is used, the ability to use water based inks for generating the desired designs/patterns, lower manufacturing costs when compared to similar polymer-based products, extremely high durability, and the ability to selectively add antimicrobial properties to the upholstery. In addition, the final upholstery product of the invention is less harmful to the environment than vinyl-based products since there are no plasticizers and no volatile organic compounds resulting in any unpleasant or unhealthy odors from off-gassing.

### Example 3

### Comparison with Solid Color Urethane Upholstery

When compared to a solid colored urethane upholstery of similar weight with an antimicrobial additive, this printed urethane provides better performance in lightfastness. and breaking strength. Furthermore there are no other printed polyurethane upholsteries that are antimicrobial.

| | solid | |
|---|---|---|
| | colored urethane | printed urethane |
| Lightfastness | 40 hours | 200 hours |
| Break Strength | | |
| warp | 144 lbs. | 258 lbs. |
| fill | 98 lbs. | 249 lbs. |
| Disinfect with Bleach | no | yes |

### EQUIVALENTS

While the present invention has been described in terms of specific methods, structures, and devices it is understood that variations and modifications will occur to those skilled in the art upon consideration of the present invention. For example, the methods and compositions discussed herein can be utilized beyond the preparation of multilayer upholsteries in some embodiments. As well, the features illustrated or described in connection with one embodiment can be combined with the features of other embodiments. Such modifications and variations are intended to be included within the scope of the present invention. Those skilled in the art will appreciate, or be able to ascertain using no more than routine experimentation, further features and advantages of the invention based on the above-described embodiments. Accordingly, the invention is not to be limited by what has been particularly shown and described, except as indicated by the appended claims.

All publications and references are herein expressly incorporated by reference in their entirety. The terms “a” and “an” can be used interchangeably, and are equivalent to the phrase “one or more” as utilized in the present application. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

What is claimed is:

1. A multilayer upholstery comprising:
a clear layer comprising a cross-linked urethane, the clear layer configured to be externally exposed;
a textile layer; and
a light-stable polymeric layer located between, and coupled to, the clear layer and the textile layer,
the multilayer upholstery having a printed pattern visible through the clear layer.

2. The multilayer upholstery of claim 1 wherein the clear layer has a thickness in a range of about 10 μm to 50 μm.

3. The multilayer upholstery of claim 1 wherein the clear layer comprises an embossed surface.

4. The multilayer upholstery of claim 1 further comprising a removable embossing paper coupled to the clear layer.

5. The multilayer upholstery of claim 1 wherein at least a portion of the clear layer is resistant to medical cleaning solutions.

6. The multilayer upholstery of claim 1 wherein at least a portion of the clear layer is resistant to bleach.

7. The multilayer upholstery of claim 1 wherein the clear layer comprises an antimicrobial additive.

8. The multilayer upholstery of claim 7 wherein the antimicrobial additive comprises at least one of an antifungal agent, an antiviral agent and an antibacterial agent.

9. The multilayer upholstery of claim 8 wherein the antibacterial agent comprises a silver-based antibacterial agent.

10. The multilayer upholstery of claim 1 wherein the cross-linked urethane comprises an aliphatic cross-linked urethane.

11. The multilayer upholstery of claim 10 wherein the cross-linked urethane further comprises at least one of a polyester and a polyether.

12. The multilayer upholstery of claim 1, wherein the cross-linked urethane comprises a polycarbonate

13. The multilayer upholstery of claim 1 wherein the clear layer directly contacts the polymeric layer.

14. The multilayer upholstery of claim 1 wherein the polymeric layer comprises a urethane-based material.

15. The multilayer upholstery of claim 1 wherein the polymeric layer is clear.

16. The multilayer upholstery of claim 1 wherein the polymeric layer comprises an acrylic-based material.

17. The multilayer upholstery of claim 1 wherein the polymeric layer has a thickness in a range of about 20 μm to 70 μm.

18. The multilayer upholstery of claim 1 wherein the printed pattern is printed on the textile layer.

19. The multilayer upholstery of claim 1 wherein the printed pattern comprises a printed film disposed between the polymeric layer and the textile layer.

20. The multilayer upholstery of claim 18 wherein the printed film comprises at least one of an ethylene acrylic acid modified polyethylene, an ethylene methylacrylic acid modified polyethylene, an ethylene vinyl acetate modified polyethylene and a similar polymer.

21. The multilayer upholstery of claim 1 wherein the textile layer comprises recycled material.

22. The multilayer upholstery of claim 1, wherein the multilayer upholstery is an exposed portion of a piece of medical furniture.

23. The multilayer upholstery of claim 1, wherein the multilayer upholstery is PVC-free.

24. The multilayer upholstery of claim 1, wherein the multilayer upholstery is configured to withstand at least about 100,000 double-rubs.

25. A multilayer upholstery comprising:
a clear layer, the clear layer comprising a cross-linked urethane, the clear layer configured to be externally exposed;
a textile layer; and
a light-stable, pigmented polymeric layer located between, and coupled to, the clear layer and the textile layer,
the multilayer upholstery having a solid color visible through the clear layer.

26. The multilayer upholstery of claim 25 wherein the clear layer comprises an embossed surface.

27. The multilayer upholstery of claim 25 wherein the clear layer has a thickness in a range of about 10 μm to 50 μm.

28. The multilayer upholstery of claim 25 wherein the clear layer directly contacts the polymeric layer.

29. The multilayer upholstery of claim 25 wherein the polymeric layer comprises an acrylic-based material.

30. The multilayer upholstery of claim 25 wherein the polymeric layer has a thickness in a range of about 35 μm to 100 μm.

31. The multilayer upholstery of claim 25, wherein the multilayer upholstery is PVC-free.

32. The multilayer upholstery of claim 25, wherein the multilayer upholstery is configured to withstand at least about 100,000 double-rubs.

33-50. (canceled)
